(19) United States
(12) Patent Application Publication
(10) Pub. No.: US 2008/0250438 A1
(43) Pub. Date: Oct. 9, 2008

(54) Emergency ejection device for a slot-in optical drive

(75) Inventors: Yao-Jia Chiou, Taoyuan (TW); Jen-Chen Wu, Taoyuan (TW)

Correspondence Address: BACON & THOMAS, PLLC, 625 SLATERS LANE, FOURTH FLOOR, ALEXANDRIA, VA, 22314-1176, US

(73) Assignee: QUANTA STORAGE INC., Taoyuan (TW)

(21) Appl. No.: 12/007,412

(22) Filed: Jan. 10, 2008

(30) Foreign Application Priority Data
Apr. 4, 2007 (TW) 96112381

(51) Int. Cl. G11B 17/04

(52) U.S. Cl. 720/620

(57) ABSTRACT

An emergency ejection device in a slot-in optical drive includes a panel with a hole. A sliding part disposes a pushing block on the path which passes through the hole into the slot-in optical drive. A guiding groove is disposed between the hole and the pushing block. The sliding part links to a loading/unloading mechanism and a rack on the sliding part engages one end of a gear set. The gear set includes a plurality of gears engaging each other one by one for transporting the power. A worm gear with a lead angle larger than the self-lock critical angle, i.e. arctan (μ/cos B), engages the other end of the gear set. A stick can put into the hole to push the pushing block backward to move the sliding part for ejecting a disc.

This application claims the benefit of Taiwan application Serial No. 96112381, filed Apr. 4, 2007, the subject matter of which is incorporated herein by reference.

### BACKGROUND OF THE INVENTION

1. Field of the Invention

The invention relates in general to a slot-in optical drive, and more particularly to an emergency ejection device capable of ejecting a disc when a slot-in optical drive breaks down or is having power cut.

2. Description of the Related Art

Disc drives are divided into tray-type disc drive and slot-in disc drive according to the way of loading or unloading a disc. When loading or unloading a disc, tray-type disc drive carries the disc by a tray. When the tray-type disc drive does not work, the tray still can be ejected for unloading the disc as long as the locking mechanism of the tray is activated. Slot-in optical drive uses a gear set to drive a deflector rod, a roller or a belt to guide the disc for loading or unloading a disc. To unload a disc from the disc drive when the slot-in optical drive does not work, the casing of the disc drive has to be dismounted. However, it is not an easy job to dismount a sophisticated slot-in optical drive. Particularly, to dismount the slot-in optical drive installed in automobile audio system, computer, or Hi-Fi stereo, a professional technician has to dismount the host first before the disc can be unloaded from the slot-in optical drive. Therefore, it is very inconvenient to unload a disc during emergency from a slot-in optical drive.

To resolve the above difficulty encountered in unloading a disc from a slot-in optical drive during emergency, an emergency ejection device for a slot-in optical disk drive is disclosed in Taiwanese Patent Publication Number 092108324 as indicated in FIG. 1. The conventional ejection device 1 includes a power supply unit which supplies power to rotate a drive gear 2 disposed at the front end of the ejection device 1. The ejection device 1 has a control switch 3 for activating or inactivating rotation of the power supply unit. Then, the drive gear 2 disposed at the front end of the ejection device 1 is inserted into a positioning hole 5 at the front end of the slot-in optical drive 4, so that the drive gear 2 is engaged with the active gear in the transmission motor of disc drive 4, wherein the active gear is adjacent to the positioning hole 5. Then, the control switch 3 is activated for rotating the drive gear 2 to drive the active gear in the transmission motor of the disc drive 4 so that the disc drive 4 can eject the disc from the disc drive via the loading/unloading slot 6.

Despite the conventional ejection device 1 can force the disc drive to eject a disc, however the ejection device 1 is a unique device which rotates the drive gear 2 disposed at the front end by eletrcticity and is not available anywhere. Ordinary consumers would not purchase an ejection device to go with a disc drive and would not bring the heavy ejection device with them all the time. In the absence of suitable tools when the disc drive breaks down, the consumers still need to send the malfunctioning disc drive to professional technician for unloading the disk.

Moreover, conventional slot-in optical drive normally uses a transmission motor to drive a worm gear. Then the gear set drives the loading/unloading mechanism to load or eject a disc. The transmission mechanism constituted by the worm gear and the gear set can not inversely rotate the worm rod by rotating the gear set or pushing the loading/unloading mechanism for ejecting a disc due to the self-lock of the worm rod and the gear set. Even a professional technician is unable to unload a disc from the slot-in optical drive through the loading/unloading slot by ordinary tools. To unload the disc, the professional technician still needs to dismount the disc drive. The way of ejecting a disc by a loading/unloading mechanism which is driven by a gear set rotated by a worm gear results in a big difference in the torque between the input end and the output end of the gear set and a big change in the rotation speed as well. Therefore, when the ejection device rotates the active gear of the motor to drive the gear set of the slot-in optical drive for ejecting a disc, a bigger power and a longer time are needed for driving the gear set of the disc drive, and the ejection of disc can not be done instantly. Thus, the conventional ejection device of a slot-in optical drive is still subjected to many restrictions that need to be resolved in practical use.

### SUMMARY OF THE INVENTION

The invention is directed to an emergency ejection device in a slot-in optical drive which changes the lead angle of a worm gear in a transmission mechanism so that the transmission mechanism is released from self-lock and the disc is ejected.

According to a first aspect of the present invention, an emergency ejection device in a slot-in optical drive is provided. The emergency ejection device reduces the torque of transmitting the gear set by a simple emergency unloading structure so that the disc can be ejected during emergency by ordinary tools, and the operation of disc ejection is simple and easy.

According to a second aspect of the present invention, an emergency ejection device in a slot-in optical drive is provided. The emergency ejection device directly moves the sliding part to drive a loading/unloading mechanism, so that the disc drive can eject the disc instantly with higher efficiency.

To achieve the above objects, the invention provides an emergency ejection device in a slot-in optical drive. The emergency ejection device includes a panel with a hole. A sliding part has a pushing block on the path which passes through the hole into the slot-in optical drive. A guiding groove is disposed between the hole and the pushing block. The sliding part is linked to a loading/unloading mechanism, and has a rack engaged with one end of a gear set. The gear set is constituted by a plurality of gears engaged with each other one by one for transporting the power. The other end of the gear set is engaged with a worm gear whose lead angle is larger than a self-lock critical angle equal to arctan (μ/cos B), wherein p denotes friction coefficient, and B denotes pressure angle. A stick can be put into the hole to push the pushing block backward to move the sliding part for ejecting a disc during emergency.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of a conventional forcing ejection device for a slot-in optical disk drive;

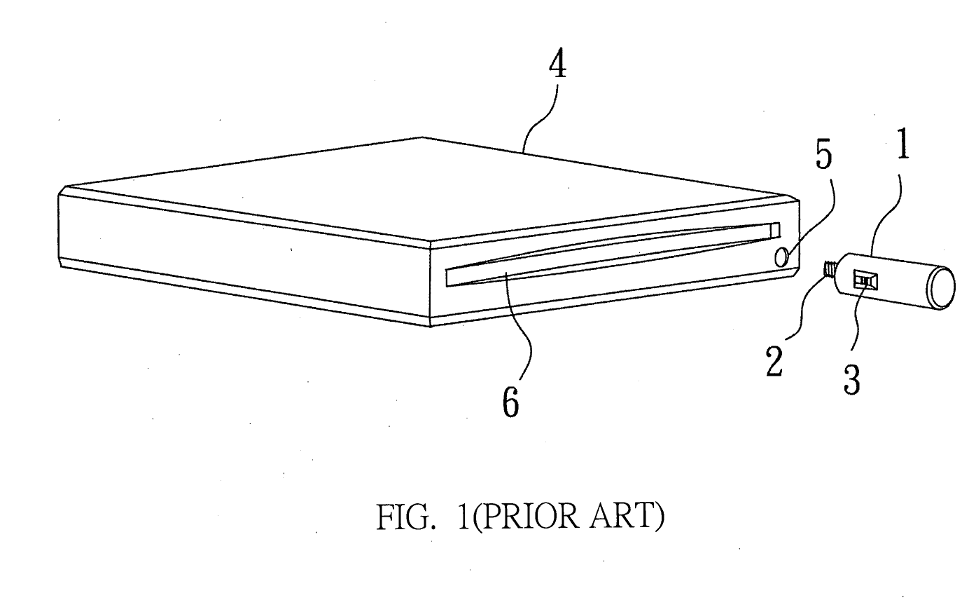

FIG. 2 is a perspective of a slot-in optical drive with an emergency ejection device of the invention;

FIG. 3 is a partial zoom-in diagram of a slot-in optical drive with the emergency ejection device of the invention; and

FIG. 4 is a relationship diagram of the operation between the worm gear and the first gear of the invention.

### DETAILED DESCRIPTION OF THE INVENTION

The technology and methods used for achieving the above objects of the invention and the functions achieved thereby are disclosed below in a preferred embodiment with accompanying drawings.

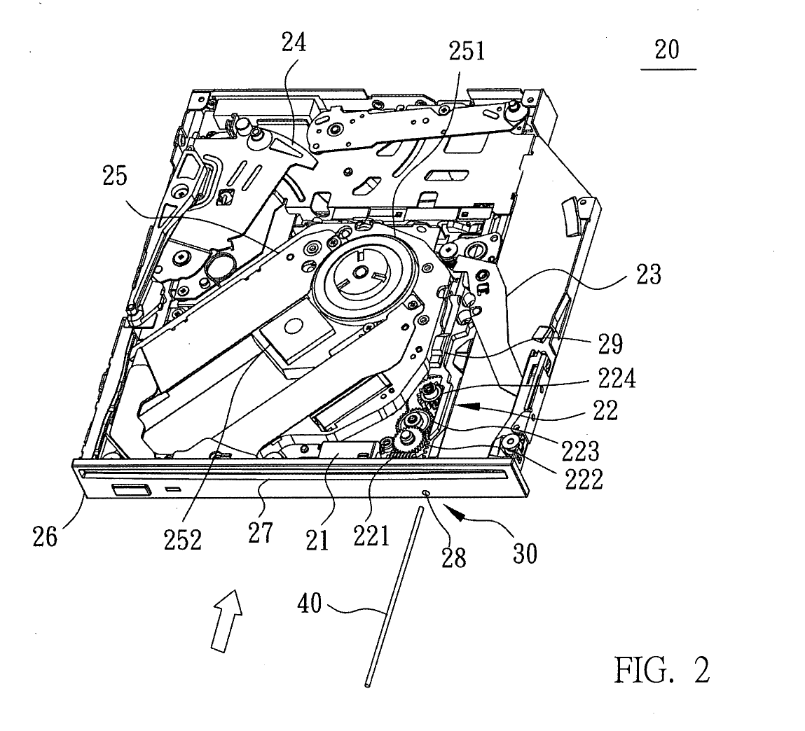

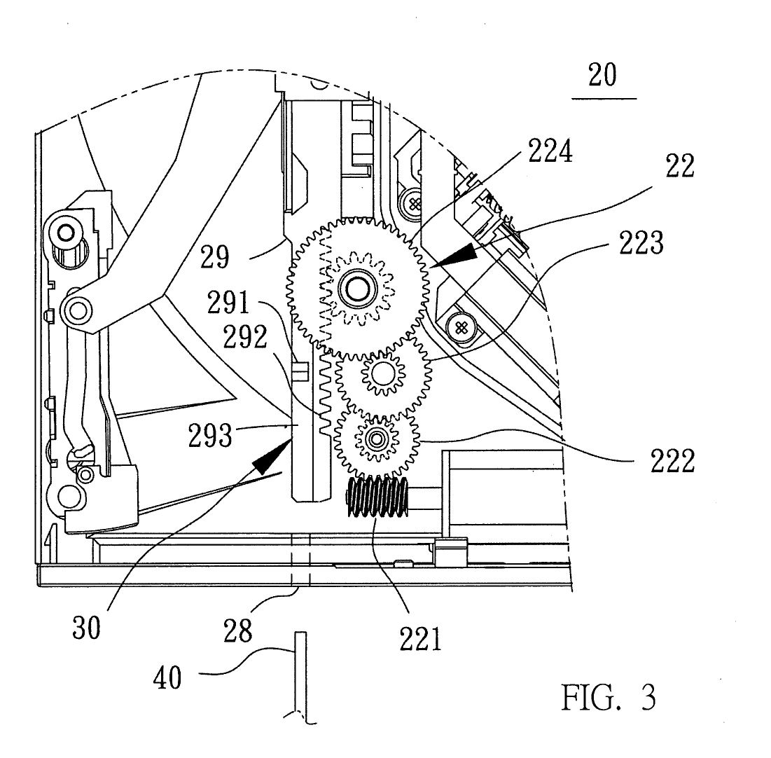

Referring to FIG. 2, a perspective of a slot-in optical drive 20 with an emergency ejection device 30 of the invention is shown. The slot-in optical drive 20 mainly includes a transmission motor 21, a gear set 22, a guiding mechanism 23, a positioning mechanism 24 and a traverse 25. A disc (not illustrated in the diagram) is inserted into the slot-in optical drive 20 through the slot 27 of the panel 26 along the arrow shown in the FIG. 2. When the disc is detected by the slot-in optical drive 20, the slot-in optical drive 20 activates the transmission motor 21, the transmission motor 21 rotates the gear set 22, whose first gear 222 is driven by the worm gear 221 disposed on the rotation axis of the transmission motor 21 for sequentially driving a second gear 223 and a third gear 224. Then, the third gear 224 drives a rack 292 (referring to FIG. 3) of the sliding part 29, so that the sliding part 29 generates a reciprocal movement for driving the guiding mechanism 23 with a deflector rod to swing and bring in the disc by its edge. Therefore, the front edge of the disc contacts with the positioning mechanism 24, thereby aligning the central hole of the disc. Meanwhile, the gear set 22 drives the positioning mechanism 24 to withdraw, so that the central hole of the disc is aligned with the position of the spindle motor 251 of the traverse 25. Then, the gear set 22 pushes the traverse 25 to rise along the guiding groove (not illustrated in the diagram) until the spindle motor 251 retains the central hole of the disc and is able to rotate the disc. The optical pick-up head 252 of the traverse 25 is then used to access data from the disc. When unloading a disc, the transmission motor 21 is rotated in an opposite direction for driving the entire gear set 22 to rotate in an opposite direction and push the traverse 25 to descend so that the spindle motor 251 can be detached from the central hole of the disc. Then, the positioning mechanism 24 moves and sends the disc to the slot 27 disposed at the front end of the slot-in optical drive 20 so that the disc can be unloaded from the disc drive. The above disclosure elaborates how the slot-in optical drive 20 loads and unloads a disc by using a transmission motor 21 to rotate a gear set 22 which drives a sliding part 29 to drive loading/unloading mechanisms including a guiding mechanism 23 and a positioning mechanism 24. The structure of a conventional slot-in optical drive 20 is referred to prior art and is not repeated here.

According to the emergency ejection device 30 of the invention, the panel 26 disposed at the front end of the slot-in optical drive 20 has a hole 28 disposed adjacent to the gear set 22. The emergency ejection device 30 is disposed in the slot-in optical drive 20 on the path along the direction extended from the hole 28. A thin stick 40 can pass through the hole 28 to activate the emergency ejection device 30 of the invention. Referring to FIG. 3, a partial zoom-in diagram of the rear view of the gear set 22 of the slot-in optical drive 20 is shown. The first gear 222, the second gear 223 and the third gear 224 each includes one large gear and one small gear, wherein the large gear and the small gear are co-axial. The first gear 222, the second gear 223 and the third gear 224 are engaged one by one to achieve force transmission. The large gear of the first gear 222 is engaged with the worm gear 221 disposed on the spindle of the transmission motor 21. The small gear of the first gear 222 is engaged with the large gear of the second gear 223. The small gear of the second gear 223 is engaged with the large gear of the third gear 224. The small gear of the third gear 224 is engaged with the rack 292 of the sliding part 29. The central axes of the first gear 222, the second gear 223 and the third gear 224 are respectively fixed in the slot-in optical drive 20. Moreover, one end of the sliding part 29 has a pushing block 291 and a guiding groove 293 on the path a thin stick 40 passing through into the hole 28. The guiding groove 293 is disposed between the hole 28 and the pushing block 291 for guiding the thin stick 40 to contact the pushing block 291 so as to move the sliding part 29.

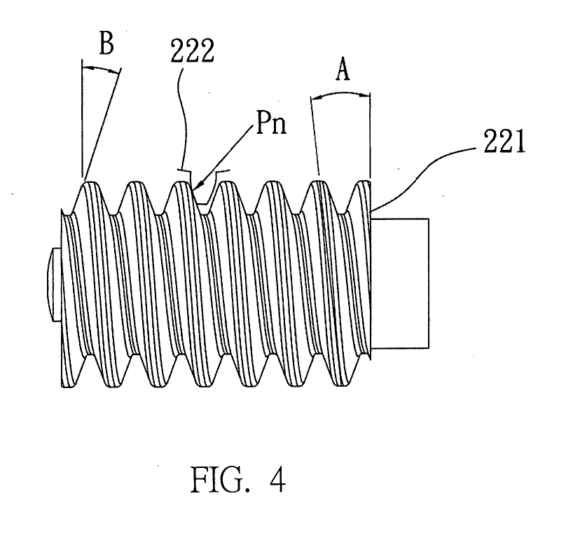

Referring to FIG. 4, a relationship diagram of the operation between the worm gear 221 and the first gear 222 of the invention is disclosed as in ordinary textbooks. That is, the relationship between the tangential force Ft received by the worm gear 221, the lead angle A of the worm gear 221 and the pressure angle B of worm gear 221 is expressed as expression (1):

Ft=Pn cos B sin A−μPn cos A (1)

wherein,
Pn: the action force perpendicular to the tooth surface;
μ: the friction coefficient

According to the above expression, when the worm gear 221 receives a tangential force Ft<0, the action force is unable to rotate the worm gear 221 such that the worm gear 221 is self-locked. To the contrary, when the worm gear 221 receives a tangential force Ft>0, the action force is able to rotate the worm gear 221. Thus, according to expression (1), when the tangential force Ft>0:

A>arctan (μ/cos B) (2)

When the lead angle A is larger than arctan (μ/cos B), the worm gear 221 will not be self-locked and can be moved. Given that the friction coefficient ∞ and the pressure angle B are fixed, the larger the lead angle A is than arctan (μ/cos B), the larger tangential force Ft the worm gear 221 receives, and the worm gear 221 also becomes much easier to be rotated. According to actual test, given that the pressure angle B and the friction coefficient p in the expression (2) are respectively equal to 20° and 0.15, the critical angle of the lead angle A is 9°. When the lead angle A is larger than 9°, the worm gear 221 will not be self-locked and can be easily rotated. However, of the worm gear of a conventional slot-in optical drive transmission system, the lead angle A is approximately 4.764° which is smaller than the critical angle 9°, so the worm gear and the gear set are self-locked and is difficult to move the transmission system to eject the disc.

The emergency ejection device 30 of the invention employs the above property that the worm gear and the gear set can not be self-locked when the lead angle A is larger than the critical angle. Referring to FIG. 3. By changing the lead angle A of the worm gear 221 in the transmission system of the slot-in optical drive 20 to be larger than the critical angle, a stick 40 is put into the hole 28 when the slot-in optical drive 20 breaks down or is having power cut and is unable to eject a disc automatically. Guided by the hole 28 and the guiding groove 293, the stick 40 contacts and moves the pushing block 291 to push the sliding part 29 backwards. Then, the rack 292 of the sliding part 29 rotates the third gear 224 and drives the entire gear set 22 to rotate via the second gear 223 and the first gear 222 subsequently so as to rotate the worm gear 221 and release the sliding part 29 from self-lock in chain. The stick 40 directly moves the sliding part 29 to drive the loading/unloading mechanism of the slot-in optical drive 20 for ejecting the disc instantly without going through the slow rotation of the gear set.

The worm gear and the gear set will be released from self-lock for ejecting a disc during emergency as long as the lead angle A is larger than the critical angle, however, the emergent ejection of disc needs be operated manually. Therefore, the required operational force should not be too large so that the convenience of operation can be maintained. Meanwhile, the required operational force should not be reduced by over-increasing the lead angle A lest the shift momentum of the loading/unloading mechanism might increase and affect the positioning precision when ejecting a disc. To obtain a better operational force for ejecting a disc during emergency, the experiment shows that in the first embodiment, given that the lead angle A=9.528° and the gear reduction ratio=122, an operational force of 5.0 Kg is required for directly pushing the sliding part to eject a disc during emergency. In the second embodiment, given that the lead angle A=14.292° and the gear reduction ratio=192, an operational force of 1.6 Kg is required for directly pushing the sliding part to eject a disc during emergency. When the lead angle A ranges between 9.528°-14.292°, the operational force required for directly pushing the sliding part to eject a disc during emergency ranges 1.6 Kg-5.0 Kg. However, the operational force in the second embodiment is more suitable to ordinary people.

By changing the lead angle of the worm gear in the transmission mechanism of the slot-in optical drive, the emergency ejection device in a slot-in optical drive of the invention enables the lead angle to be larger than the critical angle for releasing the transmission mechanism from self-lock. Meanwhile, by using a thin stick putting into a simple guiding structure consituted of the hole and the guiding groove, the sliding part can be moved by a small force, and without rotating the gear set, the torque for transmitting the gear set can be reduced for driving the loading/unloading mechanism of the slot-in optical drive to eject a disc instantly. In the above embodiment, the invention is exemplified by pushing the sliding part backward but is not limited to such type of slot-in disc drive. Any slot-in optical drive with different directions of transmission capable of ejecting a disc by changing the location or direction of the emergency ejection device of the invention is within the scope of technology of the invention. For example, instead of pushing the sliding part forward, the stick can be designed as pulling back the sliding part.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An emergency ejection device in a slot-in optical drive, comprising:
a sliding part linked to a loading/unloading mechanism, wherein a rack is disposed on the sliding part;
a gear set constituted by a plurality of gears engaged with each other one by one for transporting the power, wherein one end of the gear set is engaged with the rack; and
a worm gear engaged with the other end of the gear set, wherein the lead angle of the worm gear is larger than a self-lock critical angle.

2. The emergency ejection device in the slot-in optical drive according to claim 1, further comprising a panel with a hole, wherein the sliding part is disposed on the path which passes through the hole into the slot-in optical drive.

3. The emergency ejection device in the slot-in optical drive according to claim 2, wherein the sliding part has a pushing block on the path which passes through the hole into the slot-in optical drive.

4. The emergency ejection device in the slot-in optical drive according to claim 3, wherein the sliding part disposes a guiding groove between the hole and the pushing block on the path which passes through the hole into the slot-in optical drive.

5. The emergency ejection device in the slot-in optical drive according to claim 4, wherein a stick can be put into the hole.

6. The emergency ejection device in the slot-in optical drive according to claim 3, wherein the pushing block moves the sliding part backward for ejecting a disc during emergency.

7. The emergency ejection device in the slot-in optical drive according to claim 3, wherein the pushing block moves the sliding part forwards for ejecting a disc during emergency.

8. The emergency ejection device in the slot-in optical drive according to claim 1, wherein the self-lock critical angle is equal to arctan (μ/cos B), p denotes friction coefficient and B denotes pressure angle.

9. The emergency ejection device in the slot-in optical drive according to claim 8, wherein when the pressure angle B=20° and the friction coefficient μ=0.15, the self-lock critical angle is 9°.

10. The emergency ejection device in the slot-in optical drive according to claim 1, wherein the lead angle ranges between 9.528°-14.292°.

11. The emergency ejection device in the slot-in optical drive according to claim 10, wherein the lead angle is preferably 14.292°.
